(19) United States
(12) Patent Application Publication
(10) Pub. No.: US 2015/0064661 A1
(43) Pub. Date: Mar. 5, 2015

(54) ELECTRONIC DEVICE AND METHOD FOR MANAGING SOFTWARE TOOLS

(71) Applicant: HON HAI PRECISION INDUSTRY CO., LTD., New Taipei (TW)

(72) Inventors: YU-TEH LU, New Taipei (TW); HSIAO-PING CHIU, New Taipei (TW)

(21) Appl. No.: 14/469,561

(22) Filed: Aug. 26, 2014

(30) Foreign Application Priority Data
Aug. 27, 2013 (TW) 102130528

(51) Int. Cl. G09B 11/00

(52) U.S. Cl. CPC G09B 11/00
USPC 434/85

(57) ABSTRACT

Method of managing software tools using an electronic device includes initializing a three dimensional (3D) cube on a user interface of a software. The 3D cube includes cube surfaces. Each of the cube surfaces has been divided into blocks. A tool of the software is loaded on each of the blocks of each of the cube surfaces. In response to detecting a rotation signal on the 3D cube, a selected cube surface is determined. In response to detecting a touch signal on the selected cube surface, selected blocks on a same layer on the selected cube surface are determined, and a rotation direction of the layer is determined based on the touch signal. Current blocks are determined on the selected cube surface by rotating the layer according to the rotation direction. Icons of tools corresponding to the current blocks are displayed on the selected cube surface.

### CROSS-REFERENCE TO RELATED APPLICATIONS

This application claims priority to Taiwanese Patent Application No. 102130528 filed on Aug. 27, 2013 in the Taiwan Intellectual Property Office, the contents of which are incorporated by reference herein.

### FIELD

Embodiments of the present disclosure relate to software management technology, and particularly to managing software tools using an electronic device.

### BACKGROUND

A software (e.g., a drawing software) typically includes a plurality of tools. Icons of the tools are displayed on a user interface of the software. For example, when a user wishes to draw a line using a drawing software application, the user may use a line tool, a color tool and a style tool of the drawing software application.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a transmission system.

FIG. 2 is a block diagram of one embodiment of function modules of the transmission system in the electronic device of FIG. 1.

FIG. 3 illustrates a flowchart of one embodiment of a method for transmitting files in the electronic device of FIG. 1.

FIG. 4 illustrates a diagrammatic view of a three dimensional (3D) cube.

FIG. 5 illustrates a diagrammatic view of rotating a three dimensional (3D) cube horizontally.

FIG. 6 illustrates a diagrammatic view of rotating a three dimensional (3D) cube vertically.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”.

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

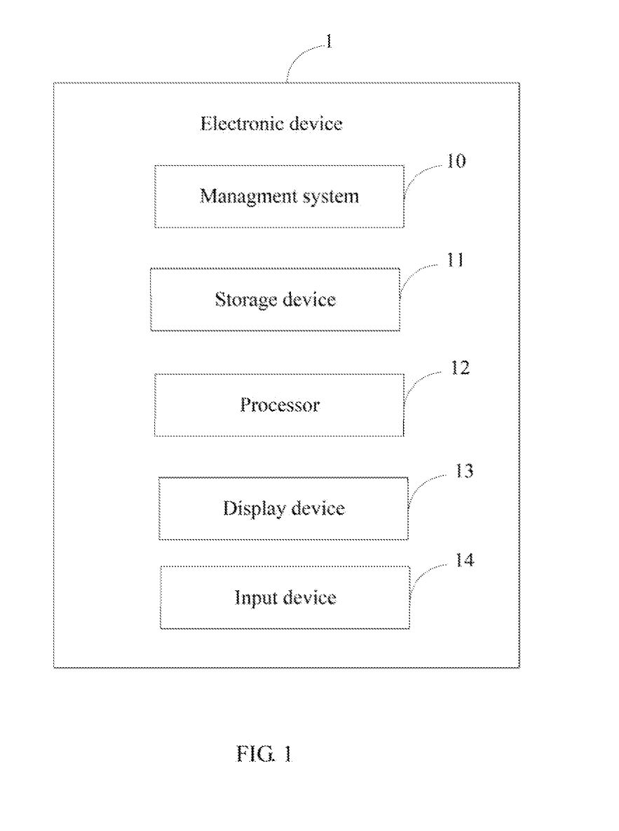

FIG. 1 illustrates a block diagram view of one embodiment of an electronic device. Depending on the embodiment, the electronic device 1 includes a management system 10. The electronic device 1 includes, but is not limited to, a storage device 11, at least one processor 12, a display device 13, and an input device 14. The electronic device 1 can be a server, a computer, a smart phone, a personal digital assistant (PDA), or other feasible electronic device. It should be understood that FIG. 1 illustrates only one example of the electronic device that can include more or fewer components than illustrated, or have a different configuration of the various components in other embodiments.

The management system 10 uses a three dimensional (3D) cube to display icons of a plurality of tools of a software. The user can select a cube surface of the 3D cube, and rotate layers of the 3D cube to determine tools on the selected cube surface. The management system 10 also provides a preview of a result by invoking one or more tools on the selected cube surface.

In at least one embodiment, the storage device 11 can include various types of non-transitory computer-readable storage mediums, such as a hard disk, a compact disc, a digital video disc, or a tape drive. The display device 13 can display images and videos, and the input device 14 can be a mouse, a keyboard, or a touch panel to input computer-readable data.

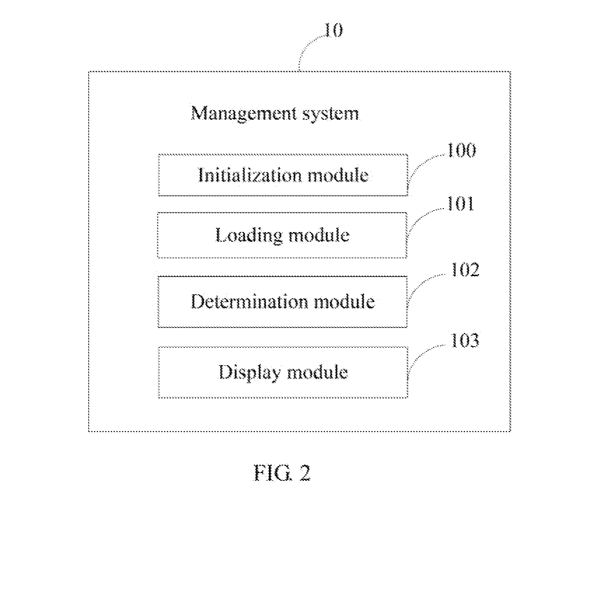

FIG. 2 is a block diagram of one embodiment of function modules of the management system. In at least one embodiment, the management system can include an initialization module 100, a loading module 101, a determination module 102, and a display module 103. The function modules 100, 101, 102 and 103 can include computerized codes in the form of one or more programs, which are stored in the storage device 11. The at least one processor executes the computerized codes to provide functions of the function modules 100-103.

The initialization module 100 displays a three dimensional (3D) cube on a user interface of a software. The 3D cube includes a plurality of cube surfaces. Each of the cube surfaces has been divided into N×N blocks and the 3D cube includes N horizontal layers and N vertical layers.

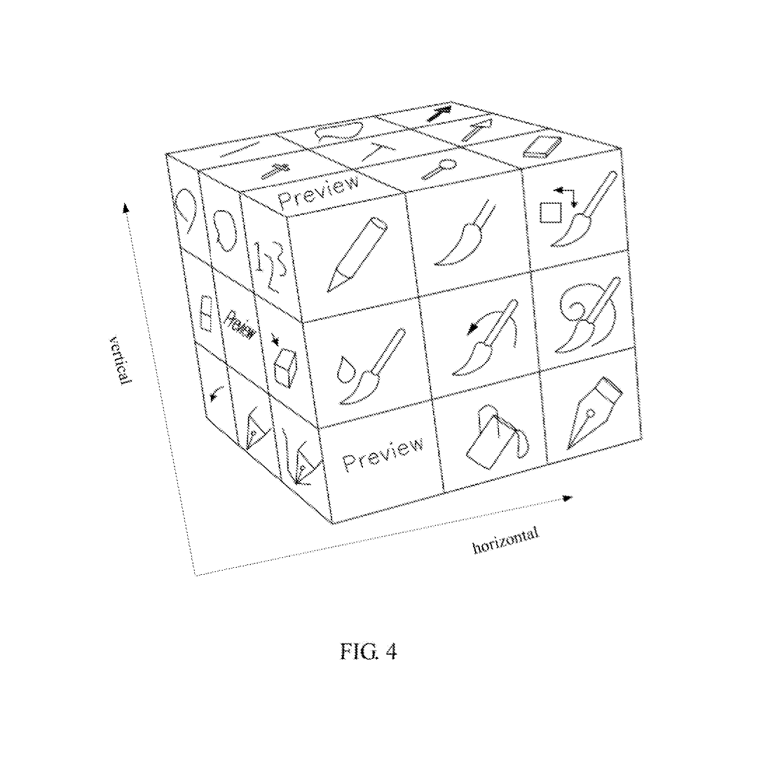

FIG. 4 illustrates, the 3D cube includes six cube surfaces. Each of the six cube surfaces is divided into 3×3 blocks. The 3D cube includes three horizontal layers, such as a first horizontal layer 50, a second horizontal layer 51 and a third horizontal layer 52. The 3D cube includes three vertical layers, such as a first vertical layer 60, a second vertical layer 61 and a third vertical layer 62.

In at least one embodiment, each of the cube surfaces corresponds to a cube surface number. Each of the N×N blocks on each of the cube surfaces corresponds to a block number. A block number of one block is represented by a three dimensional (3D) array (a, b, c), “c” represents a cube surface number of a cube surface which includes the block, “a” represents a row of the block on the cube surface, and “b” represents a column of the block on the cube surface.

The loading module 101 loads a tool of the software on each of the N×N blocks on each of the cube surfaces. As shown in FIG. 4, the loading module loads tools of a drawing software on the 3D cube. Each of the 3×3 blocks of each of the six cube surfaces corresponds to a tool of the drawing software. In at least one embodiment, each of the cube surfaces can have a preview block, which corresponds to a preview tool. A preview block on a current cube surface can show a result after invoking one or more tools on the current cube surface.

In some embodiments, a user can rotate the 3D cube to select a cube surface by executing a slide operation on the 3D cube. In other embodiments, the user can rotate the 3D cube by touching two cube surfaces simultaneously, one is a front cube surface of the 3D cube that faces to the user, the other cube surface is adjacent to the front cube surface. In response to detecting a rotation signal from a user operation, the determination module 102 rotates the 3D cube according to the rotation signal, for example, controlling the other cube surface to be the updated front cube surface. By performing the above operations, the determination module 102 can determine a current front cube surface to be a selected cube surface. In at least one embodiment, when the current front cube surface is not updated/changed within a predetermined duration, the determination module 102 determines that the current front cube surface is the selected cube surface, then the user can operate the selected cube surface.

The determination module 102 can change blocks on the selected cube surface according to user operations on the selected cube surface. In some embodiments, the user can select one or more blocks on a same layer on the selected cube surface by executing one or more touch operations (e.g., press operations or slide operations) on the blocks. In response to the touch operations of the user, the determination module 102 receives touch signals, which include press signals of the press operations and/or slide signals of the slide operations. In response to detecting the touch signals, the determination module 102 determines the selected blocks on the same layer on the selected cube surface and determines a rotation direction of the layer based on the touch signal. If the selected blocks are not on the same layer, the determination module 102 prompts the user to reselect blocks.

In at least one embodiment, if the selected blocks has a same value of “b”, the determination module 102 determines that the layer is horizontal layer. If the selected blocks has a same value of “a”, the determination module 102 determines that the layer is vertical layer. When a direction of the touch signal is positive horizontal or positive vertical, the determination module 102 determines that the rotation direction is clockwise. When the direction of the touch signal is negative horizontal or negative vertical, the determination module 102 determines that the rotation direction is counterclockwise.

In other embodiments, the user can select a single block on the selected cube surface. The determination module 102 determines a layer and a rotation direction of the single block based on the touch signal. When the rotation direction is horizontal, the determination module 102 determines that the single block is on a horizontal layer.

When the rotation direction is vertical, the determination module 102 determines that the single block is on a vertical layer. When a direction of the touch signal is positive horizontal or positive vertical, the determination module 102 determines that the rotation direction is clockwise. When the direction of the touch signal is negative horizontal or negative vertical, the determination module 102 determines that the rotation direction is counterclockwise.

The determination module 102 rotates the layer of the selected blocks according to the rotation direction, and determines current blocks on the selected cube surface after rotating the layer. In at least one embodiment, when the layer is a horizontal layer and the rotation direction is clockwise, the determination module 102 rotates the layer horizontally clockwise along a predetermined angle. When the layer is a vertical layer and the rotation direction is counterclockwise, the determination module 102 rotates the layer vertically counterclockwise along the predetermined angle.

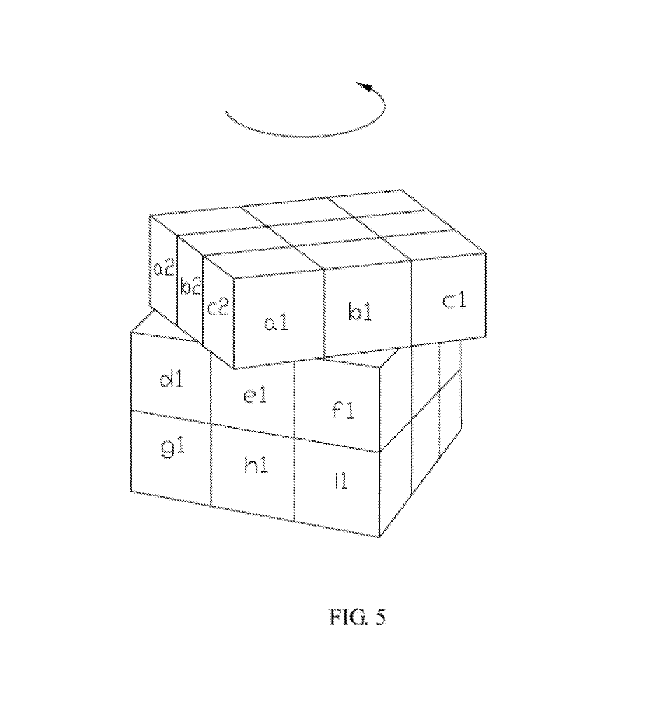

For example, as shown in FIG. 5, a selected cube surface includes nine blocks labeled a1, b1, c1, d1, e1, f1, g1, h1 and i1. It is assumed that a predetermined angle is 90 degrees, blocks a1, b1 and c1 are the selected blocks, and the rotation direction is counterclockwise. The blocks a1, b1 and c1 are located on a first horizontal layer. The determination module 102 rotates the first horizontal layer horizontally counterclockwise 90 degrees. Then the blocks a1, b1 and c1 are replaced by blocks a2, b2 and c2. The blocks a2, b2 and c2 are displayed on the selected cube surface.

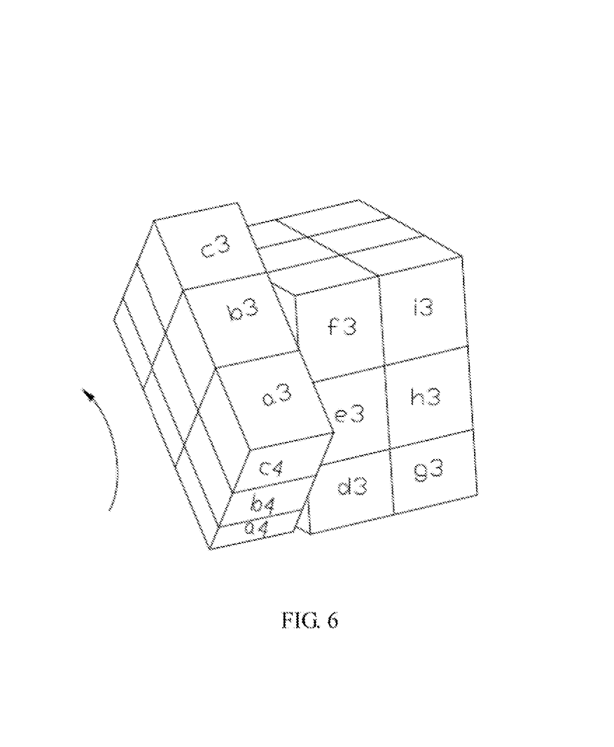

As shown in FIG. 6, a selected cube surface includes nine blocks labeled a3, b3, c3, d3, e3, f3, g3, h3 and i3. It is assumed that a predetermined angle is 90 degrees, blocks are a3, b3 and c3 are the selected blocks, and the rotation direction is clockwise. The blocks a3, b3 and c3 are located on a first vertical layer. The determination module 102 rotates the first vertical layer horizontally clockwise 90 degrees. Then the blocks a3, b3 and c3 are replaced by blocks a4, b4 and c4. The blocks a4, b4 and c4 are displayed on the selected cube surface.

The display module 103 displays icons of tools corresponding to the current blocks on the selected cube surface. In at least one embodiment, when specified current blocks on the selected cube surface are touched, the display module 103 invokes the tools corresponding to the touched current blocks on the selected cube surface, and generates a result. The display module 103 displays a preview of the result on one of the current blocks which corresponds to a preview tool.

In at least one embodiment, the tools of the software have different properties, for example, a color tool having a color property provides a plurality of colors for the user to select a color, a line width tool having a width property provides different widths for the user to select a line width. The user can determine whether the result is acceptable through the preview. If the result is unacceptable, the user can modify properties of corresponding tools.

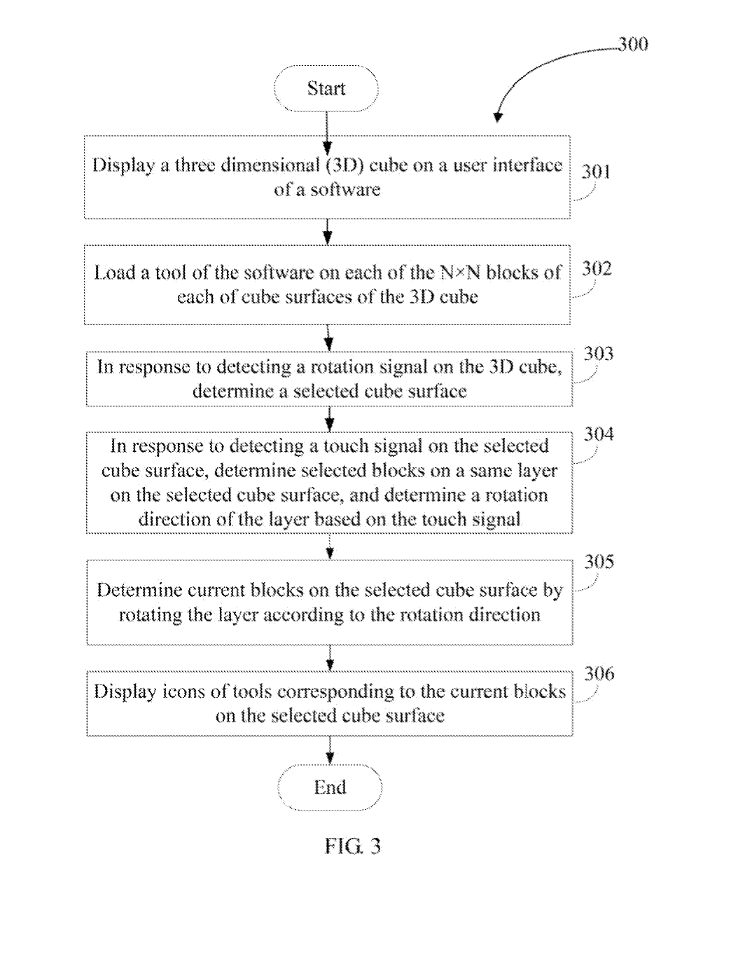

FIG. 3 illustrates a flowchart in accordance with an example embodiment. The example method 300 is provided by way of example, as there are a variety of ways to carry out the method. The method 300 described below can be carried out using the configurations illustrated in FIGS. 1, and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301. Depending on the embodiment, additional steps can be added, others removed, and the ordering of the steps can be changed.

In block 301, an initialization module displays a three dimensional (3D) cube on a user interface of a software. The 3D cube includes a plurality of cube surfaces. Each of the cube surfaces has been divided into N×N blocks and the 3D cube includes N horizontal layers and N vertical layers.

In at least one embodiment, each of the cube surfaces corresponds to a cube surface number. Each of the N×N blocks on each of the cube surfaces corresponds to a block number. A block number of one block is represented by a three dimensional (3D) array (a, b, c), “c” represents a cube surface number of a cube surface which includes the block, “a” represents a row of the block on the cube surface, and “b” represents a column of the block on the cube surface.

In block 302, a loading module loads a tool of the software on each of the N×N blocks on each of the cube surfaces. In at least one embodiment, each of the cube surfaces can have a preview block, which corresponds to a preview tool. A preview block on a current cube surface can show a result after invoking one or more tools on the current cube surface.

In block 303, in some embodiments, a user can rotate the 3D cube to select a cube surface by executing a slide operation on the 3D cube. In other embodiments, the user can rotate the 3D cube by touching two cube surfaces simultaneously, one is a front cube surface of the 3D cube that faces the user, the other cube surface is adjacent to the front cube surface. In response to detecting a rotation signal from a user operation, a determination module rotates the 3D cube according to the rotation signal, for example, controls the other cube surface to be the updated front cube surface. By performing the above operations, the determination module can determine a current front cube surface to be a selected cube surface. In at least one embodiment, when the current front cube surface is not updated within a predetermined duration, the determination module determines that the current front cube surface is the selected cube surface, then the user can operate on the selected cube surface.

In block 304, the determination module can change blocks on the selected cube surface according to user operations on the selected cube surface. In some embodiments, the user can select one or more blocks on a same layer on the selected cube surface by executing one or more touch operations (e.g., press operations or slide operations) on the blocks. In response to the touch operations of the user, the determination module receives touch signals, which include press signals of the press operations and/or slide signals of the slide operations. In response to detecting the touch signals, the determination module determines the selected blocks on the same layer on the selected cube surface and determines a rotation direction of the layer based on the touch signal. If the selected blocks are not on the same layer, the determination module prompts the user to reselect blocks.

In at least one embodiment, if the selected blocks has a same value of “b”, the determination module determines that the layer is horizontal layer. If the selected blocks has a same value of “a”, the determination module determines that the layer is vertical layer. When a direction of the touch signal is positive horizontal or positive vertical, the determination module determines that the rotation direction is clockwise. When the direction of the touch signal is negative horizontal or negative vertical, the determination module determines that the rotation direction is counterclockwise.

In other embodiments, the user can select a single block on the selected cube surface. The determination module determines a layer and a rotation direction of the single block based on the touch signal. When the rotation direction is horizontal, the determination module determines that the single block is on a horizontal layer. When the rotation direction is vertical, the determination module determines that the single block is on a vertical layer. When a direction of the touch signal is positive horizontal or positive vertical, the determination module determines that the rotation direction is clockwise. When the direction of the touch signal is negative horizontal or negative vertical, the determination module determines that the rotation direction is counterclockwise.

In block 305, the determination module rotates the layer of the selected blocks according to the rotation direction, and determines current blocks on the selected cube surface after rotating the layer. In at least one embodiment, when the layer is a horizontal layer and the rotation direction is clockwise, the determination module rotates the layer horizontally clockwise along a predetermined angle. When the layer is a vertical layer and the rotation direction is counterclockwise, the determination module rotates the layer vertically counterclockwise along the predetermined angle.

In block 306, a display module displays icons of tools corresponding to the current blocks on the selected cube surface. In at least one embodiment, when specified current blocks on the selected cube surface are touched, the display module invokes the tools corresponding to the touched current blocks on the selected cube surface, and generates a result. The display module displays a preview of the result on one of the current blocks which corresponds to a preview tool.

In some embodiments, the tools of the software have different properties, for example, a color tool having a color property provides a plurality of colors for the user to select a color, a line width tool having a width property provides different widths for the user to select a line width. The user can determine whether the result is acceptable through the preview. If the result is unacceptable, the user can modify properties of corresponding tools.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for managing software tools using an electronic device, the method comprising:
displaying a three dimensional (3D) cube on a user interface of a software, the 3D cube comprising cube surfaces, each of the cube surfaces having been divided into N×N blocks and the 3D cube comprising N horizontal layers and N vertical layers;
loading a tool of the software on each of the N×N blocks of each of the cube surfaces;
in response to detecting a rotation signal on the 3D cube, determining a selected cube surface;
in response to detecting a touch signal on the selected cube surface, determining selected blocks on a same layer on the selected cube surface and determining a rotation direction of the layer based on the touch signal;
determining current blocks on the selected cube surface by rotating the layer according to the rotation direction; and
displaying icons of tools corresponding to the current blocks on the selected cube surface.

2. The method according to claim 1, further comprising:
when specified current blocks on the selected cube surface are touched, invoking the tools corresponding to the specified current blocks on the selected cube surface, and generating a result;
displaying a preview of the result on one of the current blocks which corresponds to a preview tool.

3. The method according to claim 1, wherein each of the cube surfaces corresponds to a surface number.

4. The method according to claim 3, wherein each of the N×N blocks of each of the cube surfaces corresponds to a block number, and a block number of one block is represented by a three dimensional (3D) array (a, b, c), c representing a cube surface number of a cube surface which comprises the block, a representing a row of the block on the cube surface, b representing a column of the block on the cube surface.

5. The method according to claim 1, wherein the touch signal comprise press signals of press operations and/or slide signals of slide operations.

6. The method according to claim 1, wherein the layer is rotated by:
when the layer is a horizontal layer, rotating the layer horizontally along a predetermined angle according to the rotation direction; or
when the layer is a vertical layer, rotating the layer vertically along the predetermined angle according to the rotation direction.

7. The method according to claim 1, further comprising:
when a single block is selected on the selected cube surface, determining a layer and a rotation direction of the single block based on the touch signal, and determining that the single block is on a horizontal layer when the rotation direction is horizontal or the single block is on a vertical layer when the rotation direction is vertical.

8. An electronic device, comprising:
a processor; and
a storage device that stores one or more programs, when executed by the at least one processor, cause the at least one processor to:
display a three dimensional (3D) cube on a user interface of a software, the 3D cube comprising cube surfaces, each of the cube surfaces having been divided into N×N blocks and the 3D cube comprising N horizontal layers and N vertical layers;
load a tool of the software on each of the N×N blocks of each of the cube surfaces;
in response to detecting a rotation signal on the 3D cube, determine a selected cube surface;
in response to detecting a touch signal on the selected cube surface, determine selected blocks on a same layer on the selected cube surface and determine a rotation direction of the layer based on the touch signal;
determine current blocks on the selected cube surface by rotating the layer according to the rotation direction; and
display icons of tools corresponding to the current blocks on the selected cube surface.

9. The electronic device according to claim 8, wherein the at least one processor is caused to
when specified current blocks on the selected cube surface are touched, invoke the tools corresponding to the specified current blocks on the selected cube surface, and generate a result;
display a preview of the result on one of the current blocks which corresponds to a preview tool.

10. The electronic device according to claim 8, wherein each of the cube surfaces corresponds to a surface number.

11. The electronic device according to claim 10, wherein each of the N×N blocks of each of the cube surfaces corresponds to a block number, and a block number of one block is represented by a three dimensional (3D) array (a, b, c), c representing a cube surface number of a cube surface which comprises the block, a representing a row of the block on the cube surface, b representing a column of the block on the cube surface.

12. The electronic device according to claim 8, wherein the layer is rotated by:
when the layer is a horizontal layer, rotating the layer horizontally along a predetermined angle according to the rotation direction; or
when the layer is a vertical layer, rotating the layer vertically along the predetermined angle according to the rotation direction.

13. The electronic device according to claim 8, wherein the at least one processor is caused to:
when a single block is selected on the selected cube surface, determine a layer and a rotation direction of the single block based on the touch signal, and determine that the single block is on a horizontal layer when the rotation direction is horizontal or the single block is on a vertical layer when the rotation direction is vertical.

14. A non-transitory storage medium having stored thereon instructions that, when executed by a processor of an electronic device, causes the processor to perform a method for managing tools of a software, wherein the method comprises:
displaying a three dimensional (3D) cube on a user interface of a software, the 3D cube comprising cube surfaces, each of the cube surfaces having been divided into N×N blocks and the 3D cube comprising N horizontal layers and N vertical layers;
loading a tool of the software on each of the N×N blocks of each of the cube surfaces;
in response to detecting a rotation signal on the 3D cube, determining a selected cube surface;
in response to detecting a touch signal on the selected cube surface, determining selected blocks on a same layer on the selected cube surface and determining a rotation direction of the layer based on the touch signal;
determining current blocks on the selected cube surface by rotating the layer according to the rotation direction; and
displaying icons of tools corresponding to the current blocks on the selected cube surface.

15. The non-transitory storage medium according to claim 14, wherein the method further comprises:
when specified current blocks on the selected cube surface are touched, invoking the tools corresponding to the specified current blocks on the selected cube surface, and generating a result;
displaying a preview of the result on one of the current blocks which corresponds to a preview tool.

16. The non-transitory storage medium according to claim 14, wherein each of the cube surfaces corresponds to a surface number.

17. The non-transitory storage medium according to claim 16, wherein each of the N×N blocks of each of the cube surfaces corresponds to a block number, and a block number of one block is represented by a three dimensional (3D) array (a, b, c), c representing a cube surface number of a cube surface which comprises the block, a representing a row of the block on the cube surface, b representing a column of the block on the cube surface.

18. The non-transitory storage medium according to claim 14, wherein the layer is rotated by:
when the layer is a horizontal layer, rotating the layer horizontally along a predetermined angle according to the rotation direction; or
when the layer is a vertical layer, rotating the layer vertically along the predetermined angle according to the rotation direction.

19. The non-transitory storage medium according to claim 14, wherein the method further comprises:
when a single block is selected on the selected cube surface, determining a layer and a rotation direction of the single block based on the touch signal, and determining that the single block is on a horizontal layer when the rotation direction is horizontal or the single block is on a vertical layer when the rotation direction is vertical.
